(19) United States
(12) Patent Application Publication
(10) Pub. No.: US 2004/0266985 A1
(43) Pub. Date: Dec. 30, 2004

(54) Nitrogenated perfluoropolyether composition

(76) Inventors: Jon Lee Howell, Bear, DE (US); Krista Lynn Laugesen, Kingston (CA); Alice van der Ende, Surrey (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/869,207

(22) Filed: Jun. 16, 2004

Related U.S. Application Data
(60) Provisional application No. 60/482,816, filed on Jun. 26, 2003.

(51) Int. Cl. C08G 65/04

(52) U.S. Cl. 528/421; 528/492

(57) ABSTRACT

A nitrogenated perfluoropolyether or a composition comprising thereof is provided. The nitrogenated perfluoropolyether comprises one or more perfluoropolyether groups and an amino group wherein the perfluoropolyether group and the amino group are linked by an amide group. The nitrogenated perfluoropolyether can be produced by contacting a perfluoro acid halide with an amine under a condition sufficient to produce the nitrogenated perfluoropolyether. Also provided is a substrate having coated, impregnated, or incorporated thereon or therein a composition comprising the nitrogenated perfluoropolyether.

This application claims the benefit of provisional application 60/482,816, the entire disclosure of which is incorporated herein by reference.

### FIELD OF THE INVENTION

The invention relates to a nitrogenated perfluoropolyether composition having improved adhesion properties and incorporation attributes over the presently available perfluoropolyethers and to a process for using the composition.

### BACKGROUND OF THE INVENTION

Functionalized perfluoropolyethers are well known in the art. See, e.g., Organofluorine Chemistry—Principles and Commercial Applications, edited by Banks, Smart, and Tatlow, Plenum, (New York and London), 1994 and the references provided therein. The perfluoropolyether (PFPE) segment has a very low glass transition temperature and the inert fluids are excellent lubricants in their own right. PFPE's are known for their properties as surface treatment agents. See, e.g., EP 1006168 A1, and references therein, and Journal of Fluorine Chemistry, Volume 95, pages 51 to 70, 1999, Elsevier Press (New York), which describes amide, alcohol, or silyl amide linking groups between the PFPE and the other segment.

However, for a number of applications, an improved surface property such as, for example, enhanced adhesion is highly desirable. Development of a perfluoropolyether having such improved property would be a great contribution to the art. The invention provides a PFPE with enhanced properties by incorporating amide-linking function along with additional amino group(s), either as primary, secondary, or tertiary amines. These new compounds can have utility as coatings for metals, inorganic minerals such as stones, finely divided particles, or any surface or particle which has an affinity for an amine. Amines are known to be attracted to these types of surfaces. These new compounds can be mono- or di-functional in amine or in PFPE segment, independently, as shown in class I and II below. Additionally, amine functionalized polymers containing PFPE segments can be manufactured from these compositions. Included, but not limited to, epoxide coatings, urethanes and polyurethanes, polyamides, polyimides, and the like.

### SUMMARY OF THE INVENTION

A nitrogenated perfluoropolyether or a composition comprising thereof is provided wherein the nitrogenated perfluoropolyether comprises one or more perfluoropolyether groups and an amino group wherein the perfluoropolyether group and the amino group can be linked by an amide group.

A process that can be used for producing a nitrogenated perfluoropolyether is provided, which comprises contacting a perfluoro acid halide or a perfluoro ester with an amine under a condition sufficient to produce the nitrogenated perfluoropolyether.

### DETAILED DESCRIPTION OF THE INVENTION

An example of nitrogenated perfluoropolyether can comprise a PFPE group and an amino group, which can be derived from a primary, secondary, or tertiary amine and can be an aliphatic or aromatic amine. Illustrated examples of preferred nitrogenated perfluoropolyethers can be shown in the following two classes of compounds, or combinations thereof.

Class I: [Rf—C(O)N(R)-A-]_{(3-y)}NR′_{(y)}

Class II: [R′₂N-A-(R)NC(O)—Rf¹—C(O)N(R)-A-]_{(3-y)}NR′_{(y)}

where Rf is a polyether chain having a formula weight ranging from about 400 to about 15,000 and comprises repeat units selected from the group consisting of:

(a) J-O—(CF(CF₃)CF₂O)_{c}(CFXO)_{d}CFZ,

(b) J¹-O—(CF₂CF₂O)ₑ(CF₂O)_{f}CFZ¹, (c) J²-O—(CF(CF₃)CF₂O)ⱼCF(CF₃),

(d) J³-O—(CQ₂—CF₂CF₂—O)ₖ-CQ₂-CF₂, (e) J⁴-O—(CF₂CF₂O)₁CF₂,

(f) J³-O—(CF(CF₃)CF₂O)_{g}(CF₂CF₂O)ₕ(CFX—O)ᵢ-CFZ, and (g) combinations of two or more thereof and the units with formulae CF₂CF₂O and CF₂O are randomly distributed along the chain;

J is a fluoroalkyl group selected from the group consisting of CF₃, C₂F₅, C₃F₇, CF₂Cl, C₂F₄Cl, C₃F₆Cl, or combinations of two or more thereof;

c and d are numbers such that the c/d ratio ranges from about 0.01 to about 0.5

Z is —F, —Cl or —CF₃;

J¹ is a fluoroalkyl group selected from the group consisting of CF₃, C₂F₅, C₃F₇, CF₂Cl, C₂F₄Cl, and combinations of two or more thereof;

e and f are numbers such that the e/f ratio ranges from about 0.3 to about 5;

J² is C₂F₅, C₃F₇, or combinations thereof;

j is a number such that the formula weight of Rf ranges from about 400 to about 15,000;

J³ is selected from the group consisting of CF₃, C₂F₅, C₃F₇, and combinations of two or more thereof;

k is a number such that the formula weight of Rf ranges from about 400 to about 15,000;

each Q is independently F, Cl, or H;

J⁴ is CF₃, C₂F₅, or combinations thereof;

1 is a number such that the formula weight of Rf ranges from about 400 to about 15,000;

g, h and i are numbers such that (g+h) ranges from about 1 to about 50, the i/(g+h) ratio ranges from about 0.1 to about 0.5;

R is H, C₁-C₂₀ alkyl, aryl, substituted aryl, or combinations or two or more thereof;

R′ is H, C₁-C₂₀ alkyl, C₁-C₂₀ amino, or substituted amino, or combinations of two or more thereof;

x is about 1 to about 20, preferably 2 to 4;

y is 0 to about 2;

z is 1 to 5;

a is 0 to about 20, preferably 0 to 4;

b is 0 to about 20, preferably 0 to 4;

A is (CR₂)ₓ, (CH₂)ₐC₆R″₄(CH₂)_{b}, ([CR₂]_{z}O)ₓ and combinations thereof;

R″ is H, C₁-C₂₀ alkyl, aryl, substituted aryl, C₁-C₆ amino alkyl, halogen, nitrile, methoxy, thiomethoxy, or combinations of two or more thereof;

Rf¹ is a divalent perfluoropolyether chain segment that can have a number average formula weight of about 400 to about 15,000 and can be selected from the group consisting of (i) (CF₂CF₂O)ₑ(CF₂O)_{f}CF₂, (ii) (C₃F₆O)ₚ(CF₂CF₂O)_{q}(CFXO)ᵣCF₂, (iii) (CF₂CF₂O)(C₃F₆O)_{w}CF(CF₃), (iv) CF(CF₃)O(C₃F₆O)_{w}—Rf²—O—(C₃F₆O)_{w}CF(CF₃), (v) ((CQ₂)CF₂CF₂O)ₛCF₂CF₂, and combinations of two or more thereof and the units with formulae CF₂CF₂O and CF₂O are randomly distributed along the chain;

p, q and r are numbers such that (p+q) ranges from 1 to 50, and the r/(p+q) ratio ranges from 0.1 to 0.05, and the formula weight is from 400 to 15,000;

w is independently 2 to 45;

X is F, CF₃, or combinations thereof;

Rf² is linear or branched CₘF₂ₘ;

s is a number such that the formula weight ranges from 400 to 15,000;

Z¹ is For Cl, and

m is 1-10.

Specific examples of preferred nitrogenated perfluoropolyethers include, but are not limited to, CF(CF₃)CF₂O)ₙCF(CF₃)CONHCH₂CH₂NH₂, F(CF(CF₃)CF₂O)ₙCF(CF₃)CONHCH₂CH₂N(CH₃)₂, F(CF(CF₃)CF₂O)ₙCF(CF₃)CONHCH₂CH₂N(CH₂CH₂NH₂)₂, F(CF(CF₃)CF₂O)ₙCF(CF₃)CONHC₆H₄NH₂, F(CF(CF₃)CF₂O)ₙCF(CF₃)CONHCH(CH₃)CH₂[OCH₂CH(CH₃)]_{2.6}NH₂, F(CF(CF₃)CF₂O)ₙCF(CF₃)CONHCH(CH₃)CH₂[OCH₂CH(CH₃)]_{5.6}NH₂, F(CF(CF₃)CF₂O)ₙCF(CF₃)CONHCH₂CH₂CH₂OC₆H₁₂OCH₂CH₂CH₂NH₂F(CF(CF₃)CF₂O)ₙCF(CF₃)CONHCH₂CH₂CH₂O(C₃H₆O)₇CH₂CH₂CH₂NH₂, F(CF(CF₃)CF₂O)ₙCF(CF₃)CONH[CH(CH₃)CH₂O]CH₂C(C₂H₅)[CH₂(OCH₂CH(CH₃))₂NH₂]₂, or combinations of two or more thereof wherein n is a number from 5 to 15, or 8 to 10.

These nitrogenated perfluoropolyethers can be produced by any means known to one skilled in the art. However, it is preferred they be produced by the process described below.

A preferred process comprises contacting a perfluoro acid halide, preferably perfluoro acid fluoride, with an amine under a condition sufficient to produce the nitrogenated perfluoropolyether. More preferably, a perfluoro acid halide is first contacted with an alcohol to produce an ester followed by contacting the ester with an amine to produce the nitrogenated perfluoropolyether.

Any perfluoro acid halide can be used. Preferred perfluoro acid halide has the formula of F(CF(CF₃)CF₂O)ₙCF(CF₃)COF in which n is the same as defined above. Such acid halide can be obtained commercially from, for example, SynQuest Fluorochemicals, Alachua, Fla., USA. The perfluoro acid halide can also be produced by any means known to one skilled in the art such as, for example, Canadian Patent number 725,740 (Jan. 11, 1966).

Alternatively acid halides can be produced according to Organofluorine Chemistry, as disclosed above, and the references provided therein. The amines used for this invention come from varying chemical companies and can have about 2 to about 30, or 8 to 25, carbon atoms per molecule. The Jeffamine® Polyoxyalkyleneamines, such as the T-403 Jeffamine® (21 carbon atoms) and the D-230 Jeffamine® (12 carbon atoms), are available from Huntsman LLC, Houston, Tex. The diprimary ether amines, such as NDPA-14 (12 carbon atoms), can be obtained from Tomah Products, Inc, Milton, Wis. All other simple amines, as stated in this patent, can be purchased through Sigma-Aldrich, Milwaukee, Wis. Any alcohols, preferably anhydrous alcohols, can be used for producing the ester. Examples of suitable alcohols include methanol, ethanol, propanol, butanol, isopropanol, and combinations of two or more thereof.

The contacting of the acid halide and alcohol can be carried out under any suitable conditions. Such condition includes a temperature in the range of from about 0 to about 100° C., preferably about 15 to about 40, and more preferably 25 to 30° C.; a pressure that can accommodate the temperature range such as, for example, about 50 to about 300 kPa; and for a period of from about 5 minutes to about 10 hours. Optionally, the ester can be washed with a solvent such as water to remove excess unreacted alcohol and hydrogen halide produced. Preferably, the ester is neutralized with an alkaline material such as, for example, sodium carbonate, sodium bicarbonate, calcium carbonate, calcium bicarbonate, aluminum oxide, or combinations of two or more thereof. Because an alkaline material is well known to one skilled in the art, description of which is omitted herein.

Any amines that can react with an acid halide to produce an amide can be used in the invention. Examples of suitable amines include, but are not limited to, N, N-dimethylethylenediamine, ethylene diamine, tris(2-aminoethyl)amine, 1,4-phenylene diamine, 2-(4-aminophenyl) ethyl amine, 1,4-biphenylene diamine, bis(2-aminoethyl)amine, and combinations of two or more thereof.

The ester produced, or the acid halide, can be contacted with an amine disclosed above under a condition sufficient to effect the production of a nitrogenated perfluoropolyether. Such condition includes a temperature in the range of from about 0 to about 100° C., preferably about 15 to about 40, and more preferably 25 to 30° C.; a pressure that can accommodate the temperature range such as, for example, about 50 to about 300 kPa; and for a period of from about 5 minutes to about 10 hours.

The process can be facilitated, as known to one skilled in the art, with a mixing means such as, for example, mechanical stirring.

A nitrogenated perfluoropolyether crude product can be further purified and recovered by any means known to one skilled in the art such as, for example, distillation under atmospheric pressure up to 100° C. and/or under vacuum up to 100° C.

The process in which a nitrogenated perfluoropolyether is produced can be carried out in the presence of a solvent such as, for example, perfluorohexane, 1,1-dichloro-1-fluoroethane, hydrofluorocarbons, HFE-7100 (C₄F₉OCH₃), Freon® 134a (CF₃CH₂F), and combinations of two or more thereof. Examples of suitable hydrofluorocarbons include, perfluorobutyl methyl ether, perfluorobutyl ethyl ether, 2,4-dihydrooctafluorobutane, 1,1,2,3,3,3-hexafluoropropyl methy ether, 1,1,1,3,3-pentafluorobutane, or combinations thereof. These solvents can be obtained commercially. For example, perfluorobutyl methyl ether and perfluorobutyl ethyl ether are available from 3M Co., Minneapolis, Minn.

According to the invention, the molar ratio of alcohol to acid halide can be in the range of from about 0.9:1 to about 1.1:1, or about 0.95:1 to about 1.05:1, or 0.99:1 to 1.01:1. The molar ratio of amine to acid halide can be in the range of from about 0.5:1 to about 5:1, or about 0.8:1 to about 2:1, or 1:1 to 1.5:1. The weight of solvent, if used, as percentage of acid halide can be in the range of from about 10% to about 200%, or about 30% to about 100%, or 45% to 55%.

A substrate or product having coated, impregnated, or incorporated thereon or therein a composition comprising a nitrogenated perfluoropolyether is provided. The nitrogenated perfluoropolyether is the same as that disclosed above.

Any substrate or base material whose surface property such as, for example, adhesion can be enhanced by the nitrogenated perfluoropolyether can be used in the invention. Examples of suitable substrates include, but are not limited to metals such as aluminum and stainless steel, stone (either in architectural coatings or items of antiquity), particles, glass plate, ceramic tile, brick, concrete, wood, masonry, fiber, leather, plastics, and polymers. Examples of suitable polymer include, but are not limited to, epoxides and epoxide polymers, urethanes and poly-urethanes, polyamides such as Nylon®, polyimides, and other nitrogen-containing polymers as well as polymer additives in low concentration.

The surface on which a coating layer is formed with the nitrogenated PFPE is determined according to the shape and usage of the base material. For example, in a plate-shaped base material, the coating layer can be formed on one surface or both surfaces. In a metal part, the coating layer can be formed on the entire surface. The coating can be one or more layers.

The coating, impregnation, or incorporation of can be formed by applying such as, for example, spreading, soaking, dipping, spin-coating, roll-coating, or spraying a nitrogenated perfluoropolyether solution or dispersion onto or into the base material followed by drying by any means known to one skilled in the art. Heating may also be applied to accelerate the drying process. Usually, the drying is carried out in a temperature range of 100-350° C. for 5 minutes to 24 hours.

A solvent can be used in the preparation of a nitrogenated PFPE solution or dispersion. A suitable solvent includes, but is not limited to, toluene, xylene, hexane, heptane, butyl ether, butyl acetate, acetone, and combinations of two or more thereof. The concentration of the nitrogenated PFPE in the solution or dispersion can be in the range of from about 1 to about 100 weight % depending on the desired thickness of the coat layer or amount incorporated, the type of PFPE used. The general concentration of a nitrogenated PFPE in the solution or dispersion can be in the range of from about 10 to about 50 weight %.

If desired or necessary, the base material on which the solution or dispersion is applied can be washed with water after drying.

### EXAMPLES

### Example 1a

Into a 12 liter 3 neck flask fitted with a mechanical stirrer, thermocouple and addition funnel was placed 1738.14 g of F(CF(CF₃)CF₂O)ₙCF(CF₃)COF, n=8-10. With cooling on the reactor (−10° C. to 60° C.), 347 g anhydrous methanol was added. A mildly exothermic reaction took place and after stirring for one hour the ester, F(CF(CF₃)CF₂O)ₙCF(CF₃)COOCH₃, was washed with water to remove excess methanol and hydrogen fluoride. Final neutralization was done by filtration through a column containing CaCO₃ and Alumina. The yield was 1531 g of methyl ester.

### Example 1b

Into a 500 ml 4 neck flask fitted with a mechanical stirrer, thermocouple and addition funnel was placed 450 g of methyl ester produced in Example 1a. Perfluorobutyl methyl ether (50 ml; product code HFE-7100® (C₄F₉OCH₃)) was added. With cooling on the reactor (−10° C. to 60° C.), 23.3 g of N, N-dimethylethylenediamine was slowly added. A mildly exothermic reaction took place and after stirring for 8 hours the product was distilled at atmospheric pressure to 100° C. and with oil pump vacuum to 100° C. Multi-nuclear nmr analysis showed the compound to be F(CF(CF₃)CF₂O)CF(CF₃)C(O)NHCH₂CH₂N(CH₃)₂.

### Example 2

Into a 500 ml 4 neck flask fitted with a mechanical stirrer, thermocouple and addition funnel was placed 23.5 g of ethylene diamine. Perfluorohexane (50 ml) was added. With cooling on the reactor (−10° C. to 60° C.), 450 g of the methyl ester produced in Example 1a was slowly added over 30 minutes. A mildly exothermic reaction took place and after stirring for a couple hours the product was distilled at atmospheric pressure to 100° C. and with oil pump vacuum to 100° C. The yield was 449.72 g of product. Multi-nuclear NMR analysis showed the compound to be F(CF(CF₃)CF₂O)CF(CF₃)C(O)NHCH₂CH₂NH₂.

### Example 3

Into a 500 ml 4 neck flask fitted with a mechanical stirrer, thermocouple and addition funnel was placed 57.2 g of tris(2-aminoethyl)amine. Perfluorohexane (50 ml) was added. With cooling on the reactor (−10° C. to 60° C.), 450 g of the methyl ester from Example 1a was slowly added. A mildly exothermic reaction took place and after stirring for a couple hours the product was washed three times with 200 ml of acetone each time and distilled at atmospheric pressure to 100° C. and with oil pump vacuum to 100° C. Multi-nuclear NMR analysis showed the compound to be (CF(CF₃)CF₂O)CF(CF₃)C(O)NHCH₂CH₂N(CH₂CH₂NH₂)₂.

### Example 4

Into a 500 ml 4 neck flask fitted with a mechanical stirrer, thermocouple and addition funnel was placed 42.2 g of 1,4-phenylene diamine. Toluene (150 ml) and pyridine (25 ml) were added. With cooling on the reactor (−10° C. to 60° C.), 450 g of F(CF(CF₃)CF₂O)ₙCF(CF₃)COF, n=8 −10, was slowly added. A mildly exothermic reaction takes place and after stirring for a couple hours the product was filtered and washed three times with 200 ml of acetone. It was then distilled at atmospheric pressure to 100° C. and with oil pump vacuum to 100° C. The yield was 363.81 g of product. Multi-nuclear NMR analysis showed the compound to be F(CF(CF₃)CF₂O)CF(CF₃)C(O)NHC₆H₄NH₂, with some [F(CF(CF₃)CF₂O)CF(CF₃)C(O)NH]₂C₆H₄ also present.

### Example 5

Into a 250 ml 4 neck flask fitted with a mechanical stirrer, thermocouple and addition funnel was placed 14.5 g of D-230 Jeffamine® Polyoxyalkyleneamine. Freon® 113 (CFCl₂CF₂Cl; 50 ml) was added. With cooling on the reactor (−10° C. to 60° C.), 100 g of the methyl ester from Example 1a was slowly added. The reaction took place with no exotherm and after stirring for a couple hours the product was washed three times with 50 ml of acetone and 50 ml of water each time and distilled at atmospheric pressure to 100° C. and with oil pump vacuum to 100° C. The yield was 90.1 g of product. Multi-nuclear NMR analysis showed the compound to be F(CF(CF₃)CF₂O)ₙCF(CF₃)CONH—CH(CH₃) CH₂[OCH₂CH(CH₃)]_{2.6}NH₂.

### Example 6

Into a 250 ml 4 neck flask fitted with a mechanical stirrer, thermocouple and addition funnel was placed 14.6 g of NDPA-14 amine. Freon® 113 (50 ml) was added. With cooling on the reactor (−10° C. to 60° C.), 100 g of the methyl ester from Example 1a was slowly added. A mildly exothermic reaction took place and after stirring for a couple hours the product was washed three times with 50 ml of acetone and 50 ml of 5%NaCl/water solution each time and distilled at atmospheric pressure to 100° C. and with oil pump vacuum to 100° C. The yield was 90.0 g of product. Multi-nuclear NMR analysis showed the compound to be F(CF(CF₃)CF₂O)ₙCF(CF₃)CONHCH₂CH₂CH₂OC₆H₁₂OCH₂CH₂CH₂NH₂.

### Example 7

Into a 2 L 4 neck flask fitted with a mechanical stirrer, thermocouple and addition funnel was placed 160 g of T-403 Jeffamine® polyoxyalkyleneamine. Freon® 113 (50 ml) was added. With cooling on the reactor (−10° C. to 60° C.), 454 g of the methyl ester from Example 1a was slowly added. After stirring for a couple of days the product was washed three times with 200 ml of acetone and 200 ml of 5% NaCl/water solution each time and distilled at atmospheric pressure to 100° C. and with oil pump vacuum to 100° C. The yield was 425 g of product. Multi-nuclear NMR analysis showed the compound to be F(CF(CF₃)CF₂O)ₙCF(CF₃)CONH[CH(CH₃)CH₂O]CH₂C(C₂H₅)[CH₂(OCH₂CH(CH₃))₂NH₂]₂.

What is claimed is:

1. A composition comprising a nitrogenated perfluoropolyether, which comprises at least one perfluoropolyether group and amino group wherein said perfluoropolyether group and said amino group are optionally linked by an amide group.

2. A composition according to claim 1 wherein said composition is said nitrogenated perfluoropolyether; and said perfluoropolyether group and said amino group are linked by said amide group.

3. A composition according to claim 1 wherein said perfluoropolyether group and said amino group are linked by said amide group and said nitrogenated perfluoropolyether is [Rf-C(O)N(R)-A-]_{(3-y)}NR′_{(y)}, [R′₂N-A-(R)NC(O)-Rf¹-C(O)N(R)-A-]_{(3-y)}NR′_{(y)}, or combinations thereof wherein Rf is a polyether chain having a formula weight ranging from about 400 to about 15,000 and comprises repeat units selected from the group consisting of:
(a) J-O—(CF(CF₃)CF₂O)_{c}(CFXO)_{d}CFZ,
(b) J¹-O—(CF₂CF₂O)ₑ(CF₂O)_{f}CFZ¹, (c) J²-O—(CF(CF₃)CF₂O)ⱼCF(CF₃),
(d) J³-O—(CQ₂-CF₂CF₂—O)ₖ—CQ₂-CF₂, (e) J⁴-O—(CF₂CF₂O)₁CF₂,
(f) J³-O—(CF(CF₃)CF₂O)_{g}(CF₂CF₂O)ₕ(CFX—O)ᵢ—CFZ, and
(g) combinations of two or more thereof and the units with formulae CF₂CF₂O and CF₂O are randomly distributed along the chain;
J is a fluoroalkyl group selected from the group consisting of CF₃, C₂F₅, C₃F₇, CF₂Cl, C₂F₄Cl, C₃F₆Cl, or combinations of two or more thereof;
c and d are numbers such that the c/d ratio ranges from about 0.01 to about 0.5
Z is —F, —Cl or —CF₃;
J¹ is a fluoroalkyl group selected from the group consisting of CF₃, C₂F₅, C₃F₇, CF₂Cl, C₂F₄Cl, and combinations of two or more thereof;
e and f are numbers such that the e/f ratio ranges from about 0.3 to about 5;
J² is C₂F₅, C₃F₇, or combinations thereof;
j is a number such that the formula weight of Rf ranges from about 400 to about 15,000;
J³ is selected from the group consisting of CF₃, C₂F₅, C₃F₇, and combinations of two or more thereof;
k is a number such that the formula weight of Rf ranges from about 400 to about 15,000;
each Q is independently F, Cl, or H;
J⁴ is CF₃, C₂F₅, or combinations thereof;
l is a number such that the formula weight of Rf ranges from about 400 to about 15,000;
g, h and i are numbers such that (g+h) ranges from about 1 to about 50, the i/(g+h) ratio ranges from about 0.1 to about 0.5;
R is H, C₁-C₂₀ alkyl, aryl, substituted aryl, or combinations or two or more thereof;
R′ is H, C₁-C₂₀ alkyl, C₁-C₂₀ amino, or substituted amino, or combinations of two or more thereof;
x is about 1 to about 20;
y is 0 to about 2;
z is 1 to 5;
a is 0 to about 20;
b is 0 to about 20;
A is (CR₂)ₓ, (CH₂)ₐC₆R″₄(CH₂)_{b}, ([CR₂]_{z}O)ₓ and combinations thereof;
R″ is H, C₁-C₂₀ alkyl, aryl, substituted aryl, C₁-C₆ amino alkyl, halogen, nitrile, methoxy, thiomethoxy, or combinations of two or more thereof;
Rf¹ is a divalent perfluoropolyether chain segment that can have a number average formula weight of about 400 to about 15,000 and can be selected from the group consisting of (i) (CF₂CF₂O)ₑ(CF₂O)_{f}CF₂, (ii) (C₃F₆O)ₚ(CF₂CF₂O)_{q}(CFXO)ᵣCF₂, (iii) (CF₂CF₂O)(C₃F₆O)_{w}CF(CF₃), (iv) CF(CF₃)O(C₃F₆O)_{w}—Rf²—O—(C₃F₆O)_{w}CF(CF₃), (v) ((CQ₂)CF₂CF₂O)ₛCF₂CF₂, and combinations of two or more thereof and the units with formulae CF₂CF₂O and CF₂O are randomly distributed along the chain;
p, q and r are numbers such that (p+q) ranges from 1 to 50, and the r/(p+q) ratio ranges from 0.1 to 0.05, and the formula weight is from 400 to 15,000;
w is independently 2 to 45;
X is F, CF₃, or combinations thereof;
Rf² is linear or branched CₘF₂ₘ;
s is a number such that the formula weight ranges from 400 to 15,000;
Z¹ is F or Cl; and
m is 1-10.

4. A composition according to claim 3 wherein x is 2 to 4; a is 0 to 4; b is 0 to 4;

5. A composition according to claim 3 wherein said composition is said nitrogenated perfluoropolyether.

6. A composition according to claim 4 wherein said composition is said nitrogenated perfluoropolyether;

7. A composition according to claim 1 wherein said nitrogenated perfluoropolyether is F(CF(CF₃)CF₂O)ₙCF(CF₃)CONHCH₂CH₂NH₂, F(CF(CF₃)CF₂O)ₙCF(CF₃)CONHCH₂CH₂N(CH₃)₂, F(CF(CF₃)CF₂O)ₙCF(CF₃)CONHCH₂CH₂N(CH₂CH₂NH₂)₂, F(CF(CF₃)CF₂O)ₙCF(CF₃)CONHC₆H₄NH₂, F(CF(CF₃)CF₂O)ₙCF(CF₃)CONHCH(CH₃)CH₂[OCH₂CH(CH₃)]_{2.6}NH₂, F(CF(CF₃)CF₂O)ₙCF(CF₃)CONHCH(CH₃)CH₂[OCH₂CH(CH₃)]_{5.6}NH₂, F(CF(CF₃)CF₂O)ₙCF(CF₃)CONHCH₂CH₂CH₂OC₆H₁₂OCH₂CH₂CH₂NH₂, F(CF(CF₃)CF₂O)ₙCF(CF₃)CONHCH₂CH₂CH₂O(C₃H₆O)₇CH₂CH₂CH₂NH₂, F(CF(CF₃)CF₂O)ₙCF(CF₃)CONH[CH(CH₃)CH₂O]CH₂C(C₂H₅)[CH₂(OCH₂CH(CH₃))₂NH₂]₂, or combinations of two or more thereof wherein n is a number from 5 to 15.

8. A composition according to claim 2 wherein said nitrogenated perfluoropolyether is F(CF(CF₃)CF₂O)ₙCF(CF₃)CONHCH₂CH₂NH₂, F(CF(CF₃)CF₂O)ₙCF(CF₃)CONHCH₂CH₂N(CH₃)₂, F(CF(CF₃)CF₂O)ₙCF(CF₃)CONHCH₂CH₂N(CH₂CH₂NH₂)₂, F(CF(CF₃)CF₂O)ₙCF(CF₃)CONHC₆H₄NH₂, F(CF(CF₃)CF₂O)ₙCF(CF₃)CONHCH(CH₃)CH₂[OCH₂CH(CH₃)]_{2.6}NH₂, F(CF(CF₃)CF₂O)ₙCF(CF₃)CONHCH(CH₃)CH₂[OCH₂CH(CH₃)]_{5.6}NH₂, F(CF(CF₃)CF₂O)ₙCF(CF₃)CONHCH₂CH₂CH₂OC₆H₁₂OCH₂CH₂CH₂NH₂, F(CF(CF₃)CF₂O)ₙCF(CF₃)CONHCH₂CH₂CH₂O(C₃H₆O)₇CH₂CH₂CH₂NH₂, F(CF(CF₃)CF₂O)ₙCF(CF₃)CONH[CH(CH₃)CH₂O]CH₂C(C₂H₅)[CH₂(OCH₂CH(CH₃))₂NH₂]₂, or combinations of two or more thereof wherein n is a number from 5 to 15.

9. A substrate having coated, impregnated, or incorporated thereon or therein a composition comprising a nitrogenated perfluoropolyether, which comprises one or more perfluoropolyether groups and an amino group; and said perfluoropolyether group and said amino group are linked by an amide group.

10. A substrate according to claim 9 wherein said substrate is one or more metal, stone, particles, glass, ceramic, brick, concrete, wood, masonry, fiber, leather, plastic, or polymer.

11. A substrate according to claim 9 wherein said nitrogenated perfluoropolyether is the same as that recited in claim 3.

12. A substrate according to claim 10 wherein said nitrogenated perfluoropolyether is the same as that recited in claim 4.

13. A substrate according to claim 10 wherein said nitrogenated perfluoropolyether is the same as that recited in claim 7.

14. A process comprising contacting (1) a perfluoro acid halide with an amine to produce a nitrogenated perfluoropolyether; or (2) a perfluoro acid halide with an alcohol to produce an ester and contacting said ester with an amine to produce a nitrogenated perfluoropolyether wherein said nitrogenated perfluoropolyether comprises one or more perfluoropolyether groups and an amino group; and said perfluoropolyether group and said amino group are linked by an amide group.

15. A process according to claim 14 wherein said perfluoro acid halide is a perfluoro acid fluoride,

16. A process according to claim 14 wherein said perfluoro acid halide is F(CF(CF₃)CF₂O)ₙCF(CF₃)COF in which n is a number from 5 to 15.

17. A process according to claim 14 wherein said amine is N,N-dimethylethylenediamine, ethylene diamine, tris(2-aminoethyl)amine, 1,4-phenylene diamine, 2-(4-aminophenyl) ethyl amine, 1,4-biphenylene diamine, bis(2-aminoethyl)amine, and combinations of two or more thereof.

18. A process according to claim 17 wherein said perfluoro acid halide is F(CF(CF₃)CF₂O)ₙCF(CF₃)COF in which n is a number from 5 to 15.

19. A process according to claim 14 wherein said process comprises contacting said perfluoro acid halide with said amine.

20. A process according to claim 15 wherein said process comprises contacting said perfluoro acid halide with said amine.

21. A process according to claim 18 wherein said process comprises contacting said perfluoro acid halide with said amine.

22. A process according to claim 14 wherein said process comprises contacting said perfluoro acid halide with said alcohol to produce said ester and contacting said ester with said amine.

23. A process according to claim 15 wherein said process comprises contacting said perfluoro acid halide with said alcohol to produce said ester and contacting said ester with said amine.

24. A process according to claim 18 wherein said process comprises contacting said perfluoro acid halide with said alcohol to produce said ester and contacting said ester with said amine.

25. A process according to claim 22 wherein said alcohol is methanol, ethanol, propanol, butanol, isopropanol, or combinations of two or more thereof.

26. A process according to claim 23 wherein said alcohol is methanol, ethanol, propanol, butanol, isopropanol, or combinations of two or more thereof.

27. A process according to claim 24 wherein said alcohol is methanol, ethanol, propanol, butanol, isopropanol, or combinations of two or more thereof.

28. A process according to claim 27 wherein said ester is neutralized with a alkaline material following an optional wash with a solvent.

29. A process according to claim 28 wherein said alkaline material is sodium carbonate, sodium bicarbonate, calcium carbonate, calcium bicarbonate, aluminum oxide, or combinations of two or more thereof and said solvent is water.
